(19) United States
(12) Patent Application Publication
(10) Pub. No.: US 2010/0081458 A1
(43) Pub. Date: Apr. 1, 2010

(54) Mobile Terminal Motion Detection Methods and Systems

(75) Inventors: Leonid Sheynblat, Hillsborough, CA (US); Norman F. Krasner, Emerald Hills, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/243,792

(22) Filed: Oct. 1, 2008

(51) Int. Cl. H04W 4/02

(52) U.S. Cl. 455/456.4

(57) ABSTRACT

Methods and systems are provided for allowing possible motion or lack of motion of a mobile terminal to be detected based, at least in part, on at least one wireless signal. For example, according to one method a mobile terminal may be configured to operate in a first wireless communication system and the method may include detecting motion or lack of motion of the mobile terminal based, at least in part, on at least one wireless signal from at least one terrestrial-based second wireless communication system, and in response to detecting the motion or lack of motion, initiating or stopping at least one process within the mobile terminal.

### BACKGROUND

1. Field

The subject matter disclosed herein relates to wireless communications, and more particularly to methods and systems that allow for motion detection of a mobile terminal.

2. Information

Wireless communication systems are fast becoming one of the most prevalent technologies in the digital information arena. Cellular telephone and other like communication systems now span the entire globe. Additionally, new wireless systems (e.g., networks) of various types and sizes are added each day to provide connectivity between a plethora of devices, both fixed and portable. Many of these wireless systems are coupled together through other communication systems and resources to promote even more communication and sharing of information.

Mobile terminals in certain wireless communication systems may benefit from detecting when they are stationary and/or moved. For example, it may be beneficial to vary the operation of the mobile terminal to preserve electrical power or otherwise reduce electrical power consumption at times based on whether the mobile terminal is stationary or being moved. Some mobile terminals may include a motion detection mechanism such as, for example, a gyroscope, a compass or other like magnetic field detecting mechanism, an accelerometer, or the like, that may be used to detect motion or lack of motion. The addition of such mechanisms may, however, increase the complexity, power requirements, size, and/or cost of the mobile terminal.

### SUMMARY OF DESCRIPTION

Methods and apparatuses are provided for wireless communication systems. For example, according to one method a mobile terminal may be configured to operate in a first wireless communication system and the method may include detecting motion or lack of motion of the mobile terminal based, at least in part, on at least one-wireless signal from at least one terrestrial-based second wireless communication system, and in response to detecting the motion or lack of motion, initiating or stopping at least one process within the mobile terminal. Thus, in certain example implementations, the mobile terminal may operate in a first mode while detecting motion or lack of motion and in a second mode as a result of initiating or stopping the process. For example, in the first mode the mobile terminal may use less power than when operating in the second mode. The process that is initiated or stopped may include, for example, a location detection process or the like.

In certain implementations, detecting motion or lack of motion of the mobile terminal may include, for example, determining a change in at least an estimated proximity of the mobile terminal to at least one device of the second wireless communication system. Here, the proximity may be determined by monitoring the at least one wireless signal from the at least one device of the second wireless communication system over a period of time. Thus, for example, the change in the proximity may be determined based on a change in signal strength of the monitored wireless signal. In certain implementations, the change in the proximity may be determined based on a loss of the monitored wireless signal for a threshold amount of time. In certain implementations, the proximity may be determined by acquiring the wireless signal and identifying a change in signal propagation timing or the like.

An exemplary apparatus may be configured to operate in a first wireless communication system and include a receiver adapted to at least monitor at least one wireless signal from at least one terrestrial-based second wireless communication system, and a processing unit adapted to detect motion or lack of motion based, at least in part, on the at least one wireless signal and in response to detecting the motion or lack of motion, initiate or stop at least one process. Here, for example, the second wireless communication system may include an ultra-wideband base station, a ZigBee base station, a Bluetooth base station, a wireless network access point, a cellular micro base station, a cellular repeater, and/or the like.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is block diagram illustrating an exemplary embodiment of a system having at least two wireless communication systems, wherein at least one of the wireless communication systems includes at least one mobile terminal adapted to detect motion or lack of motion based on at least monitoring wireless signals associated with the other wireless communication system.

FIG. 2 is diagram illustrating a further exemplary embodiment of a system in accordance with FIG. 1.

FIG. 3 is a flow-diagram illustrating a method for use in detecting motion or lack of motion of a mobile terminal that may, for example, be adapted for use in the systems in FIG. 1 and FIG. 2.

FIG. 4 is a flow-diagram illustrating a method for use in estimating proximity and/or motion detection of a mobile terminal with respect to at least on device that may, for example, be adapted for use in the systems in FIG. 1 and FIG. 2, and/or method of FIG. 3.

### DETAILED DESCRIPTION

Mobile terminals in certain wireless communication systems may benefit from detecting when they are stationary and/or moved. For example, it may be beneficial to vary the operation of the mobile terminal to preserve electrical power or otherwise reduce electrical power consumption at times based on whether the mobile terminal is stationary or being moved. Some mobile terminals may include a motion detection mechanism such as, for example, a gyroscope, a compass or other like magnetic field detecting mechanism, an accelerometer, or the like, that may be used to detect motion or lack of motion. The addition of such mechanisms may, however, increase the complexity, power requirements, size, and/or cost of the mobile terminal.

Methods and systems are presented herein that may allow a mobile terminal associated with a first wireless communication system to detect possible motion or lack of motion based on one or more wireless signals associated with devices that are part of one or more other wireless communication systems. The mobile terminal may, for example, monitor such wireless signals and/or acquire and/or possibly exchange wireless signals with such device(s) to determine potential changes in the proximity of the mobile terminal with regard to the device(s). In certain implementations, the mobile terminal upon detecting such potential motion or lack of motion may, for example, initiate or stop one or more processes, change operating modes, etc. For example, the mobile terminal may initiate or stop a more accurate location detection process upon detecting such potential motion or lack of motion.

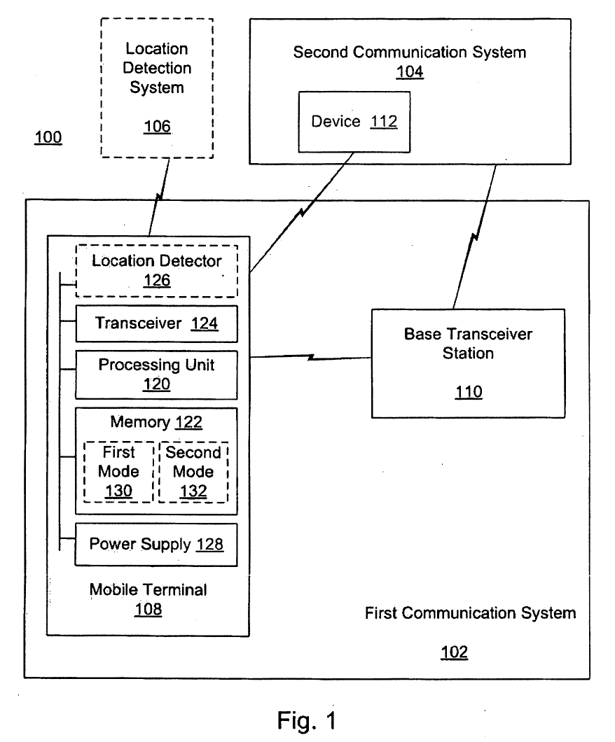

Attention is now drawn to FIG. 1, which is a block diagram illustrating a system 100 that may include a first wireless communication system 102 and at least one second wireless communication system 104. System 100 may also include a location detection system 106.

First wireless communication system 102 is representative one or more communication networks and/or services adapted to provide wireless connectivity to at least one mobile device. As shown in FIG. 1, first wireless communication system 102 may, for example, include a mobile terminal 108 and at least one base transceiver station 110. First wireless communication system 102 may also include other like wireless or wired communication and/or network devices (not shown) that are operatively adapted to provide wireless connectivity. By way of example but not limitation, first wireless communication system 102 may include a cellular telephone and/or like communication system.

Mobile terminal 108 is representative of any device that may be physically moved and is adapted to operatively communicate using at least first wireless communication system 102 through wireless signals. Thus, mobile terminal 108 may, for example, include a wireless communication device such as a radio, a telephone, a personal digital assistant (PDA), a pager, a portable computer, and/or the like. As illustrated in FIG. 1, an exemplary mobile terminal 108 may include at least one processing unit 120, memory 122, a transceiver 124, and a power supply 128. Mobile terminal 108 may also include a location detector 126.

Processing unit 120 is representative of one or more circuits adapted to perform one or more processes according to programmable instructions. Such programmable instructions may, for example, be provided in memory 122 which is representative of any circuitry that may store data. Thus, for example, memory 122 may include one or more forms of random access memory (RAM), read only memory (ROM), and/or other like computer readable medium. The data stored in memory 122 may represent programmable instructions and/or information associated with one or more processes that may be performed by the mobile terminal.

As illustrated in FIG. 1, memory 122 may include data 130 associated with a first mode of operation and data 132 associated with a second mode of operation. By way of example but not limitation, the first mode of operation may allow the mobile terminal to consume less electrical power from power supply 128 than it does in the second mode of operation. Such a location determination process may, for example, operatively employ location detector 126 and location detection system 106. By way of example but not limitation, location detection system 106 may include a satellite positioning system, and/or the like.

As will be presented in greater detail in subsequent sections, in certain exemplary implementations the first mode of operation may allow for the detection of possible motion or lack of motion of the mobile terminal based on wireless signals associated with second communication system 104 and the initiation or stoppage of at least one process based on determining such possible motion or lack of motion. Here, for example, the initiated or stopped process may act to switch the mobile terminal to a second mode of operation. In certain implementations, the initiated or stopped process and/or second mode may, for example, include/exclude a location determination process.

Transceiver 124 is representative of any circuitry that may be adapted to at least monitor a wireless signal from at least one device 112 of second communication system 104. In certain implementations, transceiver 124 may also include any circuitry that may be adapted acquire a wireless signal from at least device 112. In certain implementations, transceiver 124 may also include any circuitry that may be adapted to transmit a wireless signal to at least device 112. In still other implementations, transceiver 124 may include any circuitry that may be adapted to acquire and transmit signals to base transceiver station 110 of first communication system 102. In other implementations, transceiver 124 may include separate circuitry that may be adapted to operatively acquire and/or transmit wireless signals from/to first communication system 102 and/or second communication system 104. As part of the circuitry, transceiver 124 may include at least one antenna (not shown).

The term “monitor” as used herein with regard to a wireless signal and a mobile terminal, refers to the mobile terminal being adapted to at least detect a wireless signal, if not acquire the wireless signal. A detected signal may, for example, be one that is received in such a manner as to at least allow for a signal presence, strength or other like parameter to be measured. A detected signal may, for example, be acquired by the mobile terminal when sufficient information may be obtained from the wireless signal to enable processing of the received wireless signal to obtain data transmitted therein. Such information may include, for example, information relating to a carrier frequency, an RF phase, a code, a code-phase, timing, and/or Doppler shift, just to name a few examples. Upon successfully acquiring a wireless signal from a wireless communication system, a mobile terminal may communicate further with the wireless communication system. The actual wireless signal acquisition technique that may be implemented by the mobile terminal will depend on the wireless signaling scheme associated with the wireless communication system. Such wireless signal acquisition techniques are well known and beyond the scope of the present description.

As used herein, a wireless communication system refers to one or more devices configurable to exchange wireless signals. In FIG. 1, first communication system 102, mobile station 108, and base transceiver station 110, individually or combined, may be representative of such a wireless communication system. In certain implementations, second communication system 104 and device 112, individually or combined, may be representative of such a wireless communication system. Thus, by way of example but not limitation, wireless communication system 102 and/or 104 may include a wireless wide area network (WWAN), a wireless local area network (WLAN), a wireless personal area network (WPAN), and so on.

The term “network” and “system” are often used interchangeably. A WWAN may, for example, be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may, for example, implement one or more radio access technologies (RATs) such as cdma2000, Wideband-CDMA (W-CDMA), and so on. Cdma2000 includes IS-95, IS-2000, and IS-856 standards. A TDMA network may, for example, implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may, for example, be an IEEE 802.11x network, and a WPAN may be a Bluetooth network, an IEEE 802.15x, or some other type of network. The techniques may also be used for any combination of WWAN, WLAN and/or WPAN.

As used herein, a satellite positioning system (SPS) refers to one or more devices configurable to transmit wireless signals to mobile terminal (and/or an arrangement that may be operatively coupled to a mobile terminal) wherein the wireless signals allow the mobile terminal to determine its location (e.g., positional status) in some manner. In FIG. 1, location detection system 106 may include such a satellite positioning system. Thus, by way of example but not limitation, location detection system 106 may include the Global Positioning System (GPS), Galileo, GLONASS, NAVSTAR, Beidou, QZNSS, a system that uses satellites from a combination of these systems, or any SPS developed in the future.

Furthermore, as used herein, location detection system 106 may also include a “pseudolite” system. A pseudolite system may, for example, include ground-based transmitters that broadcast a PN code or other ranging code (similar to a GPS or CDMA cellular signal) modulated on an L-band (or other frequency) carrier signal, which may be synchronized with GPS time. Each such transmitter may, for example, be assigned a unique PN code so as to permit identification by a remote receiver such as mobile terminal 108. Such a pseudolite system may, for example, be useful in situations where GPS signals from an orbiting satellite might be unavailable, such as in tunnels, mines, buildings, urban canyons or other enclosed areas.

In certain implementations, location detection system 106 may include resources and/or devices that are part of first communication system 102, such as one or more base transceiver stations or the like which may be used to determine the location of mobile terminal 108. Such techniques are well known and beyond the scope of this description.

The methodologies described herein may be implemented by various means depending upon the application. For example, these methodologies may be implemented in hardware, firmware, software, or a combination thereof. For a hardware implementation, one or more processing units 120 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may, for example, be implemented with modules (e.g., procedures, functions, and so on) that perform the functions described herein. Any machine or computer readable medium tangibly embodying instructions may be used in implementing the methodologies described herein. For example, software codes or instructions and other data may be stored in a memory, for example memory 122 of mobile terminal 108, and executed by one or more processing units. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

Mobile terminal 108 may also include a power supply 128. Power supply 128 is representative of any circuitry that may be adapted to provide electrical power to other circuitry within mobile terminal 108. For example, power supply 128 may include one or more batteries, solar panels, or the like. Such implementations are well known.

Base transceiver station 110 may be representative of one or more devices that may be adapted to transmit and/or receive wireless signals when operatively adapted within first communication system 102. For example, as illustrated in FIG. 1, base transceiver station 110 may be adapted to exchange wireless signals with mobile terminal 108. In certain implementations, base transceiver station 110 may also be adapted to exchange wireless signals with one or more devices of second communication system 104. Although not shown in FIG. 1, base transceiver station 110 may also receive wireless signals from location detection system and possibly assist mobile terminal 108 in performing location detection.

Second communication system 104 may be representative of any wireless communication network. In certain implementations, second communication system 104 may be operatively separated from first communication system 102.

In certain implementations, second communication system 104 may be operatively coupled in some manner to first communication system 102, either directly and/or indirectly. For example, second communication system 104 may include one or more devices (e.g., repeaters or the like) that directly operatively support and/or extend the range or availability of first communication system 102. Such devices may, for example, support watermarking of the wireless signal and/or the like which may permit mobile terminal 108 to differentiate wireless signals transmitted by the device.

In other implementations, the first and second communication systems may be operatively coupled together indirectly through one or more other communication systems (not shown), such as, for example, a telephone system, the Internet, etc.

Device 112 within second communication system 104 may be terrestrial-based. Device 112 within second communication system 104 may be fixed in position. By way of further example but not limitation, device 112 may include, for example., an ultra-wideband base station, a ZigBee base station, a Bluetooth base station, a wireless network access point, a cellular micro base station, a cellular repeater or other like device.

In accordance with one aspect, mobile terminal 108 may use the short-range communication transmission capability of device 112 as a proximity detection device to help detect possible motion or lack of motion of the mobile terminal with respect thereto. As pointed out, a monitored or acquired wireless signal may be used to determine or otherwise estimate a range or change therein from mobile terminal 108 to device 112. For example, detectable wireless signal changes associated with a nearby UWB base station, ZigBee base station, Bluetooth base station, WiFi access point, cellular micro base station, SOHO repeater, and/or the like may be associated with movement of the mobile terminal with respect to the transmitting device. For example, a ZigBee base station may provide, approximately, a ten meter range similar to a Bluetooth base station, whereas a Bluetooth Class 1 base station may provide a thirty meter range and a cellular micro BTS may provide a one hundred meter range (e.g., for indoor environments). With such short ranges, an absolute or substantially accurate proximity of the mobile terminal 108 with respect to device 112 may not be needed to determine motion or lack of motion of the mobile terminal. Instead, possible motion or lack of motion may be detected based, at least in part, on a perceived change or difference in the range to device 112. For example, an increase or decrease in amplitude of a wireless signal, the presence of a new wireless signal, the loss of an existing wireless signal, an increase or decrease in signal propagation timing, a handover from one device 112 to another device 112, and/or other like signal conditions through signal monitoring and/or signal acquisition may be indicative of motion of the mobile terminal. Conversely, a lack of a significant increase or decrease in amplitude of a wireless signal, the lack of a presence of a new wireless signal, continued receipt of an existing wireless signal, a lack of a significant increase or decrease in signal propagation timing, a lack of a handover from one device 112 to another device 112, and/or a lack of other like signal conditions through signal monitoring and/or signal acquisition may be indicative of a lack of motion of the mobile terminal.

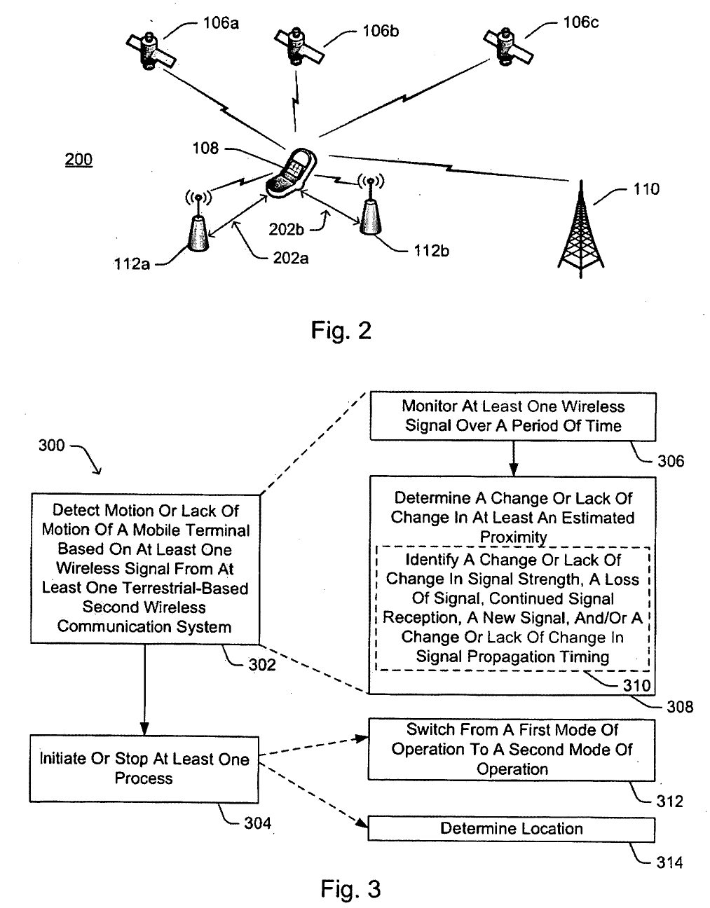

FIG. 2 is an illustrative diagram further depicting a system 200, similar to system 100, wherein mobile terminal 108 may monitor wireless signals from devices 112a and/or 112b and based thereon determine possible motion or lack of motion. Here, mobile station 108 is represented by a cellular phone and devices 112a and 112b are represented by terrestrial-based base station antennas. As further illustrated, mobile terminal 108 may be adapted to selectively communicate to base transceiver station 110, which is represented here by a tower antenna. Mobile terminal 108 may also receive signals from a satellite positioning system represented here by three satellites 106a, 106b and 106c.

In FIG. 2, mobile terminal 108 is illustrated as having an estimated proximity 202a to device 112a and an estimated proximity 202b to device 112b. If either estimated proximity 202a and/or 202b change, then mobile terminal 108 may detect motion or lack of motion. Upon detecting motion or lack of motion, mobile terminal 108 may switch from a first mode of operation to a second mode of operation. The first mode of operation may, for example, include a power consumption reduction mode that may affect communications with base transceiver station 110, location detection operations, etc. The second mode of operation may, for example, include one or more processes that in some manner affect communications with base transceiver station 110, location detection operations, etc.

FIG. 3 is a flow-diagram illustrating a method 300 of which at least a portion may be implemented or otherwise adapted for use within systems 100 and/or 200.

At block 302, motion or lack of motion of a mobile terminal may be detected based, at least in part, on at least one wireless signal from at least one terrestrial-based second wireless communication system. For example, block 302 may include, at block 306, monitoring at least one wireless signal over a period of time. At block 308, a change is at least an estimated proximity of the mobile terminal to a transmitting device of the second wireless communication system may be determined. By way of example, block 308 may include, at block 310, identifying a change in signal strength, loss of a signal, a new signal, and/or change in signal propagation timing. At blocks 302, 306 and/or 308, the monitored signal may be acquired.

At block 304, at least one process may be initiated or stopped in response to detecting motion or lack of motion at block 302. For example, block 304 may include, at block 312, switching from a first mode of operation to a second mode of operation. For example, block 304 may include, at block 314, determining a location of the mobile terminal.

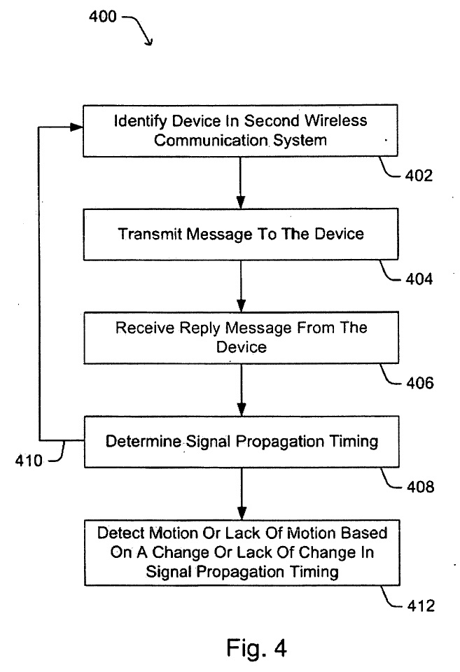

FIG. 4 is a flow diagram illustrating a method 400 that may be used for estimating a change in proximity between a mobile terminal and a device wherein at least a portion of method 400 may be implemented or otherwise adapted for use within systems 100 and/or 200, and/or method 300.

At block 402, at least one device in at least one second wireless communication system may be identified by a mobile terminal that may be adapted for use in at least a first wireless communication system. The device may, for example, acquire a wireless signal from the device that identifies the presence of the device. At block 404, the mobile terminal may transmit at least one message to the device. By way of example but not limitation, the mobile terminal may send one or more messages that “ping” the device or otherwise communicate with the device in some manner that leads the device to transmit at least one message in reply. At block 406, the mobile terminal may receive at least one reply message from the device.

At block 408, the mobile terminal may determine signal propagation timing, for example, based on the message exchange at blocks 404 and 406. For example, round-trip signal propagation timing may be determined based, at least in part, on measuring the amount of time from the transmitted message at block 404 and reception of the reply message at block 406. In certain implementations, signal propagation timing may be determined based, at least in part, on timestamp or other like time indicative information provided to the mobile station within the reply message. In certain implementations, the device may, for example, be adapted to transmit the reply message after a delay period from the receipt of the message from the mobile terminal at block 404. Such a delay may, for example, be a predetermined delay period that the mobile terminal is already aware of, and/or the reply message may include time information associated with or otherwise indicative of the delay period. In certain implementations, the delay period may not be known by the mobile terminal.

As illustrated by arrow 410, method 400 may include repeating one or more of the functions at blocks 402-408. For example, in certain implementations it may be beneficial to exchange several messages between the mobile terminal and the device over a period of time to allow for the signal propagation timing at block 408 to be determined in a statistical manner. For example, averaged or other like statistically determined signal propagation timing over one or more periods of time may provide for improved proximity estimations to detect possible motion or lack of motion of the mobile terminal with respect to the device based on a change in signal propagation timing as in block 412. Thus, for example, if during a first period of time an average round-trip signal propagation timing was determined to be t_{avg}, and during a subsequent period of time an average round trip signal propagation timing was determined to be less than or greater than t_{avg}, then it may be determined that the proximity of the mobile station to the device has changed and that therefore motion may be detected. Conversely, for example, if during a first period of time an average round-trip signal propagation timing was determined to be t_{avg}, and during a subsequent period of time an average round trip signal propagation timing was determined to be significantly unchanged (i.e., about t_{avg}), then it may be determined that the proximity of the mobile station to the device has not significantly changed and that therefore a lack of motion may be detected. In certain implementations, other statistical information and/or threshold parameters may be considered to provide for further improved proximity estimations for motion detection.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method for use in a wireless mobile terminal configured to operate in a first wireless communication system, the method comprising:
detecting motion or lack of motion of said mobile terminal based, at least in part, on at least one wireless signal from at least one terrestrial-based second wireless communication system; and
in response to detecting said motion or said lack of motion, initiating or stopping at least one process within said mobile terminal.

2. The method as recited in claim 1, wherein said mobile terminal is operating in a first mode while detecting motion or lack of motion and in a second mode as a result of initiating /or stopping said at least one process.

3. The method as recited in claim 2, wherein when operating in said first mode said mobile terminal uses less power than when operating in said second mode.

4. The method as recited in claim 1, wherein said at least one process comprises a location detection process.

5. The method as recited in claim 1, wherein detecting motion or lack of motion of said mobile terminal comprises determining a change or a lack of change in at least an estimated proximity of said mobile terminal to at least one device of said second wireless communication system.

6. The method as recited in claim 5, wherein said proximity is determined by monitoring said at least one wireless signal from said at least one device of said second wireless communication system over a period of time.

7. The method as recited in claim 6, wherein said change in said proximity is determined based on a change or a lack of change in signal strength of said monitored wireless signal.

8. The method as recited in claim 7, wherein said change in said proximity is determined based on a loss :of said monitored wireless signal for a threshold amount of time.

9. The method as recited in claim 5, wherein said proximity is determined by acquiring said wireless signal and identifying a change or a lack of change in signal propagation timing.

10. The method as recited in claim 1, wherein said second wireless communication system comprises at least one of an ultra-wideband base station, a ZigBee base station, a Bluetooth base station, a wireless network access point, and/or at least one system enhancement device that adaptively establishes said second communication system by operatively enhancing said first communication system.

11. An apparatus configured to operate in a first wireless communication system, the apparatus comprising:
a receiver adapted to at least monitor at least one wireless signal from at least one terrestrial-based second wireless communication system; and
a processing unit operatively coupled to said receiver and adapted to detect motion or lack of motion based, at least in part, on said at least one wireless signal and in response to detecting said motion or said lack of motion, initiate or stop at least one process.

12. The apparatus as recited in claim 11 wherein the apparatus is operated in a first mode to detect motion or lack of motion and in a second mode as a result of initiation or stoppage of said at least one process.

13. The apparatus as recited in claim 12, wherein when in said first mode the apparatus uses less power than when operating in said second mode.

14. The apparatus as recited in claim 11, further comprising:
a location detector operatively coupled to at least said processing unit and adapted to determine a location of the apparatus in response to initiation or stoppage of said at least one process.

15. The apparatus as recited in claim 11, wherein said processing unit is adapted to determine a change or a lack of change in at least an estimated proximity to at least one device of said second wireless communication system.

16. The apparatus as recited in claim 15, wherein said proximity is determined by at least monitoring said at least one wireless signal from said at least one device of said second wireless communication system over a period of time.

17. The apparatus as recited in claim 16, wherein said change in said proximity is determined based on a change or a lack of change in signal strength of said monitored wireless signal.

18. The apparatus as recited in claim 17, wherein said change in said proximity is determined based on a loss of said monitored wireless signal for a threshold amount of time.

19. The apparatus as recited in claim 15, wherein said proximity is determined by acquiring said wireless signal with said receiver and identifying a change or a lack of change in signal propagation timing with said processing unit.

20. The apparatus as recited in claim 11, wherein said second wireless communication system comprises at least one of an ultra-wideband base station, a ZigBee base station, a Bluetooth base station, a wireless network access point a cellular micro base station, and/or a cellular repeater.

21. An apparatus for use in a wireless mobile terminal configured to operate in a first wireless communication system, the apparatus comprising:
means for detecting motion or lack of motion of a mobile terminal based, at least in part, on at least one wireless signal from at: least one terrestrial-based second wireless communication system; and
means for initiating or stopping at least one process within said mobile terminal in response to detecting said motion or said lack of motion.

22. The apparatus as recited in claim 21, wherein said mobile terminal is operates in a first mode with said means for detecting motion or lack of motion of said mobile terminal and in a second mode as a result of said means for initiating or stopping at least one process within said mobile terminal.

23. The apparatus as recited in claim 22, wherein when operating in said first mode said mobile terminal uses less power than when operating in said second mode.

24. The apparatus as recited in claim 21, wherein said at least one process comprises a means for location detection.

25. The apparatus as recited in claim 21, wherein said means for detecting motion or lack of motion of said mobile terminal comprises means for determining a change or a lack of change in at least an estimated proximity of said mobile terminal to at least one device of said second wireless communication system.

26. The apparatus as recited in claim 25, wherein said proximity is determined by means for monitoring said at least one wireless signal from said at least one device of said second wireless communication system over a period of time.

27. The apparatus as recited in claim 26, wherein said change in said proximity is determined based on a change or a lack of change in signal strength of said monitored wireless signal.

28. The apparatus as recited in claim 27, wherein said change in said proximity is determined based on a loss of said monitored wireless signal for a threshold amount of time.

29. The apparatus as recited in claim 25, wherein said proximity is determined by acquiring said wireless signal and identifying a change or a lack of change in signal propagation timing.

30. The apparatus as recited in claim 21, wherein said second wireless communication system comprises at least one of an ultra-wideband base station, a ZigBee base station, a Bluetooth base station, a wireless network access point, and/or at:least one system enhancement device that adaptively establishes said second communication system by operatively enhancing said first communication system.

31. A computer readable medium comprising computer implementable instructions stored thereon which if implemented by at least one processing unit within a mobile terminal operatively enable the at least one processing unit to:
initiate or stop at least one process within a mobile terminal in response to detecting motion or lack of motion of a mobile terminal based, at least in part, on at least one wireless signal from at least one terrestrial-based second wireless communication system.

32. The computer readable medium as recited in claim 31, wherein said mobile terminal is operatively enable to operate in a first mode while detecting motion or lack of motion and in a second mode after initiating or stopping said at least one process.

33. The computer readable medium as recited in claim 32, wherein when operating in said first mode said mobile terminal uses less power than when operating in said second mode.

34. The computer readable medium as recited in claim 31, wherein said at least one process comprises a location detection process.

35. The computer readable medium as recited in claim 31, comprising further computer implementable instructions stored thereon which if implemented by the at least one processing unit operatively enable the at least one processing unit to:
determine a change or a lack of change in at least an estimated proximity of said mobile terminal to at least one device of said second wireless communication system.

36. The computer readable medium as recited in claim 35, wherein said proximity is determined by monitoring said at least one wireless signal from said at least one device of said second wireless communication system over a period of time.

37. The computer readable medium as recited in claim 36, wherein said change in said proximity is determined based on a change or a lack of change in signal strength of said monitored wireless signal.

38. The computer readable medium as recited in claim 37, wherein said change in said proximity is determined based on a loss of said monitored wireless signal for a threshold amount of time.

39. The computer readable medium as recited in claim 35, wherein said proximity is determined by acquiring said wireless signal and identifying a change or a lack of change in signal propagation timing.

40. The computer readable medium as recited in claim 31, wherein said second wireless:communication system comprises at least one of an ultra-wideband base station, a. ZigBee base station, a Bluetooth base station, a wireless network access point, and/or at least one system enhancement device that adaptively establishes said second communication system by operatively enhancing said first communication system.
